(19) United States
(12) Patent Application Publication
(10) Pub. No.: US 2026/0216856 A1
(43) Pub. Date: Jul. 30, 2026

(54) POWER TOOL

(71) Applicant: JIANGSU DONGCHENG M&E TOOLS CO., LTD., NANTONG, JIANGSU (CN)

(72) Inventors: WENBIN LU, NANTONG, JIANGSU (CN); GONGYUAN FAN, NANTONG, JIANGSU (CN)

(21) Appl. No.: 19/143,930

(22) PCT Filed: Nov. 8, 2024
(86) PCT No.: PCT/CN2024/130767

§ 371 Date: Jun. 27, 2025

(30) Foreign Application Priority Data
Nov. 24, 2023 (CN) 202311588647.6

(51) Int. Cl. B25F 5/02; A01G 3/08; H02K 7/116; H02K 7/14

(52) U.S. Cl. CPC B25F 5/02; A01G 3/086; H02K 7/116; H02K 7/145

(57) ABSTRACT

The present application belongs to the technical field of garden devices, and in particular to a power tool. The power tool includes a housing (10), a first holding part (40) located on a top side of the housing (10), and a second holding part (50) located on a side surface of the housing (10). The second holding part (50) includes a first fixed part (51) and a second fixed part (52) connected to the housing (10), and the first holding part (40) is connected to a first connection area (13) and a second connection area (14) of the housing (10). When viewed from a left-right direction perpendicular to a front-back direction, a first axis (X1) intersects with a second axis (X2), and an angle between the first axis (X1) and the second axis (X2) is greater than or equal to 40° and less than or equal to 85°. Therefore, when a user holds and operates the power tool with two hands, the angle between the user's two hands is neither too small to cause fatigue nor too large to limit the holding area of one hand, thereby not affecting the user experience.

### CROSS-REFERENCE TO RELATED APPLICATIONS

The present application is a 35 U.S.C. § 371 National Phase conversion of International (PCT) Patent Application No. PCT/CN2024/130767, filed Nov. 8, 2024, which claims priority to Chinese Patent Application No. 202311588647.6, filed Nov. 24, 2023, both of which are herein incorporated by reference in their entirety.

### TECHNICAL FIELD

The present disclosure relates to the technical field of garden devices, and in particular to a power tool.

### BACKGROUND

As a common type of garden power tool, a chain saw includes a housing, a motor accommodated in the housing, and a battery pack providing power to the motor. In order to adapt to different operating angles and user operating habits, the chain saw is usually equipped with a main handle located on a top side of the housing and a side handle located on a side of the housing. A certain angle is defined between the side handle and the main handle. When the angle is too small, it causes a distance between two hands of the user to be too small during operation, making operation uncomfortable for the user. When the angle is too large, it causes the user to hold only a small area where the side handle is bent, so as to save effort during operation, making it difficult to adapt to multi-angle operating scenarios.

In view of this, it is necessary to provide an improved power tool to overcome shortcomings in the related art.

### SUMMARY OF THE DISCLOSURE

In a first aspect, the present disclosure provides a power tool including a housing, a first holding part, and a second holding part. The housing extends in a front-back direction and includes a first connection area and a second connection area. The first holding part is located on a top side of the housing. A front end of the first holding part is connected to the first connection area, a rear end of the first holding part is connected to the second connection area, and the first holding part extends along a first axis. The second holding part is located on a side surface of the housing. The second holding part includes a first fixed part and a second fixed part both connected to the housing. The first fixed part and the second fixed part are connected to form a second axis. When viewed from a left-right direction perpendicular to the front-back direction, the first axis intersects with the second axis, and an angle between the first axis and the second axis is greater than or equal to 40° and less than or equal to 85°.

In an embodiment of the power tool of the present disclosure, the second holding part includes a first section, a second section, and a third section. The first section extends from the first fixed part. The second section extends from the second fixed part. The third section) is connected to the first section and the second section. The second holding part includes an effective holding area located on at least one of the first section and the third section, and a length of the effective holding area decreases as the angle between the first axis and the second axis increases.

In an embodiment of the power tool of the present disclosure, when viewed from the left-right direction, an intersection point of the first axis and the second axis is located in the first connection area, and the angle between the first axis and the second axis is greater than or equal to 45° and less than or equal to 65°.

In an embodiment of the power tool of the present disclosure, in the up-down direction perpendicular to the front-back direction, a gravity center of the power tool is located between the first fixed part and the second fixed part.

In an embodiment of the power tool of the present disclosure, the power tool further includes a functional assembly accommodated in the housing. The functional assembly includes a motor, a gear assembly, and a gearbox. The motor is configured to drive an operating assembly that extends forward from a front end of the housing. The gear assembly is in transmission connection with the motor. The gearbox is configured for accommodating the gear assembly. The functional assembly is provided with a contour area composed of an outer contour of the gearbox and an outer contour of the motor. When viewed from the left-right direction, the second fixed part is at least partially located in the contour area.

In an embodiment of the power tool of the present disclosure, the motor shaft of the motor extends in the left-right direction, and the output shaft of the gear assembly is disposed parallel to the motor shaft. In the front-back direction, a center of the second fixed part is located between the motor shaft and the output shaft.

In an embodiment of the power tool of the present disclosure, the operating assembly includes a guiding plate extending along a third axis, and the first fixed part and the second fixed part are located on both sides of the third axis in an up-down direction perpendicular to the front-back direction, respectively.

In an embodiment of the power tool of the present disclosure, an angle between the first axis and the third axis ranges from 0° to 15°.

In an embodiment of the power tool of the present disclosure, in a plane parallel to the guiding plate, a fourth axis is formed by connecting a center of a motor shaft and a center of an output shaft, and an angle between the fourth axis and the third axis is an acute angle. In a plane parallel to the guiding plate, a projection point of the second fixed part is located on a lower front side of a projection point of the motor shaft.

In an embodiment of the power tool of the present disclosure, the gravity center of the power tool is located between the motor shaft and the output shaft in the front-back direction.

In an embodiment of the power tool of the present disclosure, the second holding part is configured as a linear connection structure or a curved structure between the first fixed part and the second fixed part.

In an embodiment of the power tool of the present disclosure, the housing includes an air inlet and an air outlet in fluid communication with the air inlet, and an airflow channel is formed between the air inlet and the air outlet. The power tool further includes a motor, a fan, a controller, and a battery pack. The motor is accommodated in the housing and located in the airflow channel. The fan is driven to rotate by the motor. The controller is electrically connected to the motor. The controller is located upstream of the motor in the airflow channel, and the controller is disposed close to the air inlet. The battery pack is detachably connected to the rear end of the housing. In the front-back direction, the air inlet is located between the motor and the battery pack.

In an embodiment of the power tool of the present disclosure, the housing defines a first chamber and a second chamber. The first chamber is configured to accommodate the motor and defines an air outlet. The second chamber is configured to accommodate the controller and defines an air inlet. The first chamber is in fluid communication with the second chamber.

In an embodiment of the power tool of the present disclosure, the power tool further includes a partition device disposed between the first chamber and the second chamber. The partition device includes a partition plate and a cover. The partition plate extends parallel to the controller. A channel configured for allowing the airflow to flow is formed between the controller and the partition plate, so as to guide the airflow entering from the air inlet to the first chamber.

In an embodiment of the power tool of the present disclosure, the partition device includes a cover, and the cover includes a diversion wall and a transverse wall. The diversion wall is disposed around the periphery of the fan, and the diversion wall defines a guiding port corresponding to the air outlet. The transverse wall is connected between the diversion wall and the motor, separating the first chamber and the second chamber. The transverse wall and the partition plate form a fluid opening connecting the first chamber and the second chamber.

In a second aspect, in another power tool of the present disclosure, the power tool includes a housing, a motor, a first holding part, and a second holding part. The motor is received in the housing. The housing extends in a front-back direction and includes a first connection area and a second connection area. The first holding part is located on a top side of the housing, a front end of the first holding part is connected to the first connection area, and a rear end of the first holding part is connected to the second connection area. The first holding part extends along the first axis. The second holding part is located on a side surface of the housing, and the second holding part includes a first fixed part and a second fixed part both connected to the housing. The first fixed part and the second fixed part are connected to form a second axis. When viewed from a left-right direction, the first axis intersects with the second axis, and the motor is at least partially located in an angle between the first axis and the second axis.

In an embodiment of the power tool according to the second aspect of the present disclosure, an intersection point of the first axis and the second axis is located in the first connection area.

In a third aspect, in yet another power tool of the present disclosure, the power tool includes a housing, a motor, a first holding part, and a second holding part. The housing extends in a front-back direction. The motor includes a motor shaft extending in a left-right direction perpendicular to the front-back direction. The first holding part is located on a top side of the housing. The second holding part is located on a side surface of the housing. The second holding part includes a first fixed part and a second fixed part both connected to the housing, and the second fixed part is located at a front side of the motor shaft in the front-back direction.

In an embodiment of the power tool according to the third aspect of the present disclosure, the second holding part includes an effective holding area, and a length of the effective holding area decreases as a distance between the motor shaft and the second fixed part increases in the front-back direction.

In an embodiment of the power tool according to the third aspect of the present disclosure, the power tool further includes a gear assembly including an output shaft, and the second holding part is between the output shaft and the motor shaft in the front-back direction.

### BRIEF DESCRIPTION OF THE DRAWINGS

FIG. 1 is a front view of a power tool in an embodiment of the present disclosure.

FIG. 2 is a rear view of the power tool of FIG. 1.

FIG. 3 is a bottom view of the power tool of FIG. 1.

FIG. 4 is a schematic view of the power tool of FIG. 1 with a part of a housing removed.

FIG. 5 is a partial cross-sectional view of the power tool of FIG. 3.

FIG. 6 is a structural schematic view illustrating a motor and a cover of the power tool of FIG. 1.

FIG. 7 is a front view of a second holding part in a second embodiment of the present disclosure.

FIG. 8 is a front view of a second holding part in a third embodiment of the present disclosure.

### DETAILED DESCRIPTION

The present disclosure is further described in detail with reference to accompanying drawings and embodiments.

The terms used in the present disclosure are merely for the purpose of describing specific embodiments and are not intended to limit the present disclosure. For example, the terms indicating orientation or positional relationships, such as “up”, “down”, “front”, “back”, and “rear”, are based on orientation or positional relationships in the accompanying drawings. They are only intended to facilitate the description of the present disclosure and simplify the description, but do not indicate or imply that the device or the element referred to must have a specific orientation, be constructed and operated in the specific orientation. Therefore, it cannot be understood as a limitation on the present disclosure.

In response to the shortcomings in the related art, a purpose of the present disclosure is to provide a power tool, so that it is comfortable for a user to operate the power tool.

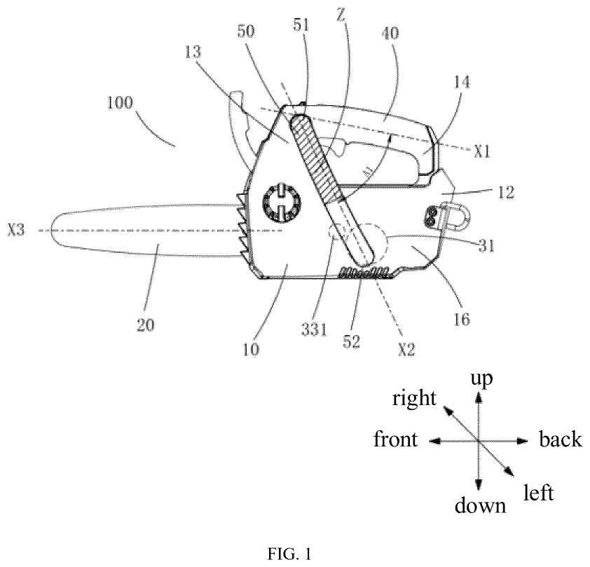

As illustrated in FIGS. 1 to 4, the present disclosure relates to a power tool. In some embodiments, the power tool is a chain saw 100. The chain saw 100 includes a housing 10 that extends substantially in a front-back direction, an operating assembly 20 that extends forward from a front end of the housing 10, a functional assembly 30 that is at least partially accommodated in the housing 10, and a battery pack (not shown in figures) that is detachably connected to a rear end of the housing 10.

The operating assembly 20 includes a guiding plate 21 and a chain (not shown in figures). The guiding plate 21 is detachably connected to the front end of the housing 10, and the chain is fixed on periphery of the guiding plate 21. The functional assembly 30 includes a motor 31 configured for driving the operating assembly 20, a controller 32 electrically connected to the motor 31, a gear assembly 33 that is in transmission connection with the motor 31, and a gearbox 34 configured for accommodating the gear assembly 33. In some embodiments, the motor 31 is received in the housing 10. The battery pack is configured to supply power to the motor 31, so as to drive the chain to rotate around the periphery of the guiding plate 21, thereby achieving a cutting operation.

The motor 31 is an external rotor motor. The motor 31 includes a motor shaft 311, a stator, and a rotor. The motor shaft 311 extends in a left-right direction perpendicular to the front-back direction. The stator and the rotor are connected to the motor shaft 311. The gear assembly 33 includes an output shaft 331 disposed parallel to the motor shaft 311, a large gear connected to an end of the output shaft 331, and a small gear connected to an end of the motor shaft 311. The small gear meshes with the large gear, so as to perform transmission.

The housing 10 includes a body part 11 configured for accommodating the functional assembly 30, and a battery pack installation part 12 located on a rear end of the body part 11. The battery pack installation part 12 extends obliquely, so that the battery pack is obliquely fixed on the rear end of the housing 10. The chain saw 100 includes a first holding part 40 and a second holding part 50 for a user to hold. The first holding part 40 is located on a top side of the housing 10, and the first holding part 40 is spaced apart from the body part 11 by a certain holding area. In some embodiments, the second holding part 50 is between the output shaft 331 and the motor shaft 311 in the front-back direction. The housing 10 includes a first connection area 13 connected to a front end of the first holding part 40 and a second connection area 14 connected to a rear end of the first holding part 40. A size of the first connection area 13 in an up-down direction is greater than that of the second connection area 14 in the up-down direction, so that the first holding part 40 extends obliquely along a first axis X1. The guiding plate 21 of the operating assembly 20 extends along a third axis X3, and an angle of 0-15° is defined between the first axis X1 of the first holding part 40 and the third axis X3 of the guiding plate 21. The inclined first holding part 40 is more convenient for the uses to hold.

The second holding part 50 is located on a side surface of the housing 10. The second holding part 50 includes a first fixed part 51 connected to the housing 10, a second fixed part 52 connected to the housing 10, a first section 53 extending laterally from the first fixed part 51, a second section 54 extending laterally from the second fixed part 52, and a third section 55 connected to the first section 53 and the second section 54. The first fixed part 51 is at least partially located in the first connection area 13, and the second fixed part 52 is located between the first connection area 13 and the second connection area 14 in the front-back direction.

In some embodiments, the first fixed part 51 and the second fixed part 52 are connected to form a second axis X2, and an intersection point of the first axis X1 and the second axis X2 is disposed in the first connection area 13. When viewed from the left-right direction perpendicular to the front-back direction, the first axis X1 intersects with the second axis X2, and an angle Al defined between the first axis X1 and the second axis X2 is greater than or equal to 40° and less than or equal to 85°. This setting ensures that when the user operates the chain saw 100, the distance between the right hand holding the first holding part 40 and the left hand holding the second holding part 50 is neither too large nor too small, creating a comfortable hold state. The first axis X1 intersects with the second axis X2, and the motor 31 is at least partially located in an angle between the first axis X1 and the second axis X2.

When the user uses the chain saw 100 for cutting, the user holds the holding part of the chain saw 100 with two hands. In order to adapt to different operating angles or scenarios, the user subconsciously chooses a comfortable holding area. This holding area that the user subconsciously chooses is called an effective holding area Z. After multiple tests, a size of the effective holding area Z is affected by a size of the angle between the first axis X1 and the second axis X2, a position of the second fixed part 52 fixed to the housing 10, and a position of a gravity center G of an entire machine. A length of the effective holding area Z decreases as the angle between the first axis X1 and the second axis X2 increases. In some embodiments, the length of the effective holding area Z decreases as a distance between the motor shaft 311 and the second fixed part 52 increases in the front-back direction.

The following examples may be provided with reference to FIGS. 1 to 8, illustrating several different positions of the second fixed part 52.

As illustrated in FIGS. 1 to 5, the functional assembly 30 is provided with a contour area 35, and the contour area 35 is composed of an outer contour of the gearbox 34 and an outer contour of the motor 31. When viewed from the left-right direction, the second fixed part 52 is at least partially located in the contour area 35. In this case, the angle between the first axis X1 and the second axis X2 ranges from 40° to 75° (including 40° and 75°), and the gravity center G of entire chain saw 100 is located in an area enclosed by this angle. In the up-down direction, the gravity center G of the entire machine is located between the first fixed part 51 and the second fixed part 52. When the angle between the first axis X1 and the second axis X2 is 40°, the effective holding area Z includes a lateral holding area of the first section 53, a bending holding area between the first section 53 and the third section 55, and a lateral holding area of the third section 55 located above the gravity center G. The user can choose a specific position to hold in the effective holding area Z according to different operating scenarios. The user's palm naturally tilts downwards or upwards at a certain angle, which is a comfortable hold state. The angle between the left hand and the right hand may not be too small, thereby not affecting the operating experience. When the angle between the first axis X1 and the second axis X2 is 75°, the effective holding area Z includes the lateral holding area of the first section 53, the bending holding area between the first section 53 and the third section 55, and a small part of the lateral holding area of the third section 55 close to the bending holding area. In this case, when the user holds on the third section 55, the palm of the left hand has a certain upward tilt angle, and the hold comfort is significantly lower than the above embodiments.

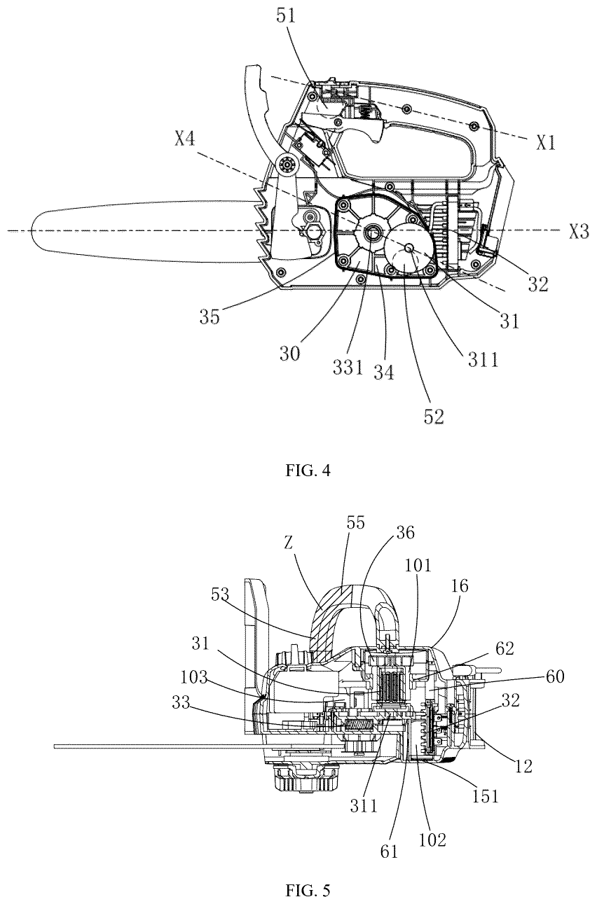

As illustrated in FIGS. 1 and 4, for further optimization, the motor shaft 311 and the output shaft 331 are connected to form a fourth axis X4, and an angle between the third axis X3 and the fourth axis X4 is an acute angle. In some embodiments, the second fixed part 52 is located at a front side of the motor shaft 311 in the front-back direction. In some embodiments, the second fixed part 52 is disposed on a front lower side of the motor shaft 311. In some embodiments, a center of the second fixed part 52 is disposed between the motor shaft 311 and the output shaft 331 in the front-back direction. In this case, the angle between the first axis X1 and the second axis X2 ranges from 50° to 60° (including 50° and 60°). The effective holding area Z includes the lateral holding area of the first section 53, the bending holding area between the first section 53 and the third section 55, and the lateral holding area of the third section 55 located above the gravity center G. The User can choose the specific position to hold in the effective holding area Z according to different operating scenarios. The user's palm naturally tilts downwards or upwards at a certain angle, which is the comfortable hold state. The angle between the left hand and the right hand may not be too small, thereby not affecting the operating experience.

As illustrated in FIG. 7, the second fixed part 52 is located directly below the first fixed part 51. In this case, an angle A2 between the first axis X1 and the second axis X2 is 85°. The effective holding area Z includes the lateral holding area of the first section 53 and the bending holding area between the first section 53 and the third section 55. In this effective holding area Z, the user's palm naturally tilts downwards, providing a comfortable hold. In the case where the second fixed part 52 is moved forward, when the user holds, the effective holding area only includes a part of the first section 53. When holding other parts, the user's palm may tilt downwards and the wrist may bend upwards. Prolonged operation in this position can easily cause the wrist soreness and a poor experience.

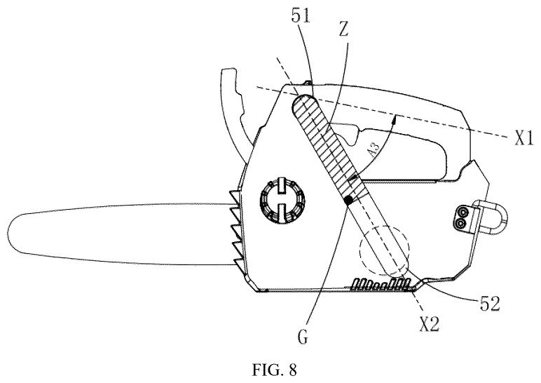

As illustrated in FIG. 8, the second fixed part 52 is at least partially located in the contour area 35 of the motor 31 in the front-back direction. When the center of the second fixed part 52 is flush with a rear end edge of the motor 31 in the front-back direction, an angle A3 between the first axis X1 and the second axis X2 is 45°. In this case, when viewed from the left-right direction, the gravity center G of entire chain saw 100 substantially coincides with the third section 55 of the second holding part 50, and the effective holding area Z includes the lateral holding area of the first section 53, the bending holding area between the first section 53 and the third section 55, and the lateral holding area of the third section 55 located above the gravity center G.

The first fixed part 51 and the second fixed part 52 of the second holding part 50 are connected to form the second axis X2, and the angle between the second axis X2 and the first axis X1 of the first holding part 40 ranges from 40° to 85°. Therefore, when the user holds and operates the power tool with two hands, the angle between the user's two hands is neither too small to cause fatigue nor too large to limit the holding area of one hand, thereby not affecting the user experience.

The chain saw 100 further includes a tensioning device located on the other side of the housing 10, the tensioning device is opposite to the second holding part 50, and the tensioning device is configured to tension the chain. When tensioned, the users usually place the chain saw 100 on a desktop, and the chain saw 100 is supported on the desktop by the second holding part 50. Therefore, a length of the second holding part 50 in the up-down direction must be able to stably support the entire machine when placed on the desktop. In some embodiments, the first fixed part 51 and the second fixed part 52 are respectively located on both sides of the third axis X3 of the guiding plate 21 in the up-down direction, so that the chain saw 100 can be stably placed on the desktop through the second holding part 50 and the battery pack installation part 12.

As illustrated in FIG. 5, the first fixed part 51 and the second fixed part 52 are fixed to the housing 10 by screws. The housing 10 defines fixing holes, and the first fixed part 51 and the second fixed part 52 are correspondingly provided with installation holes. The screws pass through the fixing holes of the housing 10 from interior of the housing 10 and enter the installation holes, thereby beautifying the appearance and preventing the screws from being exposed and rusting.

In the above embodiments, the second holding part 50 is configured as a linear connection structure between the first fixed part 51 and the second fixed part 52. In some embodiments, in order to enhance the effective holding area, a structure between the first fixed part 51 and the second fixed part 52 can also be configured as a curved structure. For example, it may be laterally curved in the left-right direction, obliquely curved in the up-down direction, or rotationally curved in the front-back direction, etc., which may not be described in detail here.

As illustrated in FIGS. 1 to 5, the housing 10 includes a first housing 15 and a second housing 16 connected to the first housing 15. The first housing 15 and the second housing 16 are assembled to form a chamber that accommodates the functional assembly 30. The chamber includes a first chamber 101 that accommodates the motor 31, a second chamber 102 that accommodates the controller 32, and a third chamber 103 that accommodates the gearbox 34. The first chamber 101 and the second chamber 102 are in fluid communication. In the front-back direction, the first chamber 101 and the second chamber 102 are disposed in a staggered manner.

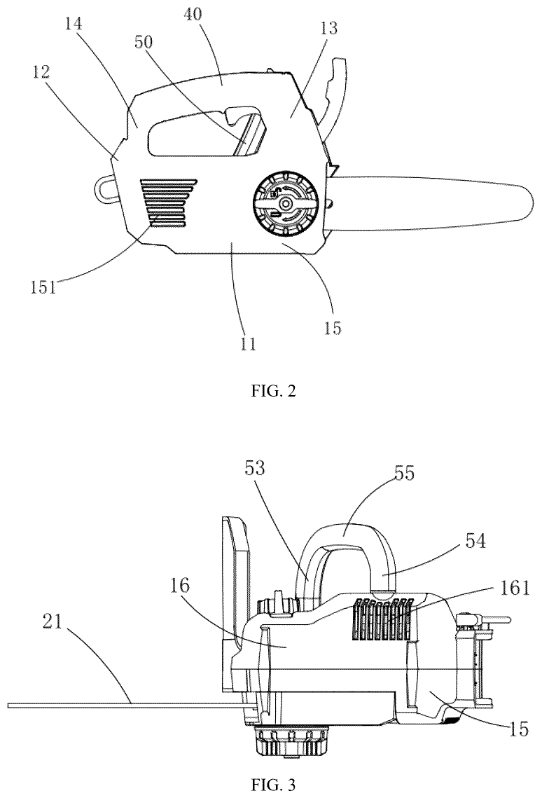

As illustrated in FIGS. 2 and 3, the housing 10 defines an air inlet 151 located on a side surface of the first housing 15 and an air outlet 161 located on a bottom surface of the second housing 16. The air inlet 151 is in fluid communication with the air outlet 161, and an airflow channel is formed between the air inlet 151 and the air outlet 161. The second holding part 50 is connected to the second housing 16. The air inlet 151 is disposed in the second chamber 102, and the air outlet 161 is disposed in the first chamber 101. That is, the second chamber 102 is in fluid communication with external air through the air inlet 151, and the first chamber 101 is in fluid communication with the external air through the air outlet 161.

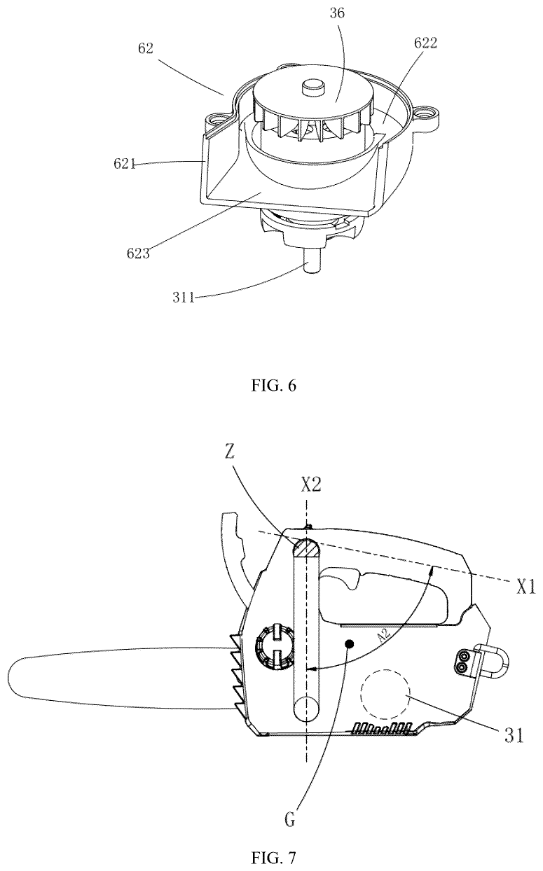

As illustrated in FIGS. 5 and 6, the functional assembly 30 further includes a fan 36 connected to an end of the motor shaft 311. The motor 31 and the controller 32 are located in the airflow channel between the air inlet 151 and the air outlet 161. The motor 31 drives the fan 36 to rotate, so that a pressure difference is formed inside and outside the housing 10. Under influence of the pressure difference, external air enters the second chamber 102 from the air inlet 151, flows or passes through the controller 32, and then enters the first chamber 101. After flowing or passing through a gap of the motor 31, the air flows out of the housing 10 through the air outlet 161.

The air inlet 151 is located between the motor 31 and the battery pack in the front-back direction, and the controller 32 is located upstream of the motor 31 and close to the air inlet 151 in the airflow channel, as shown in FIGS. 2 and 5. In some embodiments, the motor 31 is horizontally placed in the first chamber 101. The controller 32 is vertically placed in the second chamber 102, and a side of the controller 32 is substantially closely adjacent to the air inlet 151. This arrangement allows cooling airflow formed by the external air to enter the housing 10 and first flow through a surface of the controller 32, thereby dissipating heat from the controller 32. In order to improve the heat dissipation effect, in some embodiments, a size of the air inlet 151 in the up-down direction perpendicular to the front-back direction and the left-right direction is substantially the same as a height of the controller 32.

The motor 31 and the controller 32 are staggered in the front-back direction. In the left-right direction, the controller 32 is located between the air inlet 151 and the motor 31, the fan 36 is located on a side of the motor 31 away from the controller 32, and the air outlet 161 is disposed close to the fan 36. When viewed from the front-back direction, the controller 32 at least partially coincides with the motor 31 or the battery pack. When viewed from the up-down direction perpendicular to the front-back direction, the controller 32 is located between the motor 31 and the battery pack, and the controller 32 is spaced apart from the motor 31 and the battery pack. This arrangement ensures that a certain heat dissipation space is among three main heat-generating structures of the controller 32, the motor 31, and the battery pack, preventing them from being too close to each other, thereby avoiding affecting their respective heat dissipation effect.

The chain saw 100 includes a partition device 60 disposed between the first chamber 101 and the second chamber 102. The partition device 60 includes a partition plate 61 extending parallel to the controller 32 and a cover 62 at least partially surrounding the fan 36. The partition plate 61 is formed by extending inwardly from an inner wall of the first housing 15, and a channel that is configured for allowing the airflow to flow is formed between the partition plate 61 and the controller 32. An extending length of the partition plate 61 in the left-right direction is greater than or equal to half of the size (i.e., a width of the controller 32) of the controller 32 in the left-right direction, so as to guide the air entering the air inlet 151 to flow through at least half of the surface of the controller 32, thereby improving the cooling effect of the controller 32. In addition, there is a certain distance between an end of the partition plate 61 in the left-right direction and the motor 31, so that the airflow in the first chamber 101 can enter the first chamber 101 under guidance of the partition plate 61 after flowing through the surface of the controller 32, thereby cooling the motor 31.

As illustrated in FIGS. 5 and 6, the cover 62 is detachably connected to the second housing 16. The cover 62 includes a diversion wall 621 surrounding periphery of the fan 36 and a transverse wall 622 connected between the diversion wall 621 and the motor 31. A guiding port 623 corresponding to the air outlet 161 is defined on the diversion wall 621. The first chamber 101 is physically separated from the second chamber 102 by the diversion wall 621, the transverse wall 622, and the partition plate 61. Therefore, the hot airflow flowing through the motor 31 flows directly out of the air outlet 161 under the guidance of the diversion wall 621, without flowing back from periphery of the motor 31 to the first chamber 101 and without causing the intersection of cold airflow and hot airflow. A fluid opening connecting the first chamber 101 and the second chamber 102 is formed between the transverse wall 622 and the partition plate 61, and the airflow flowing through the controller 32 enters the second chamber 102 from the fluid opening. In addition, the air outlet 161 is disposed on the bottom surface of the second housing 16, and the hot airflow flowing through the motor 31 and flowing out of the air outlet 161 cannot blow onto the user or affect the cutting operation.

As illustrated in FIG. 4, the fourth axis X4 is formed by connecting the motor shaft 311 and the output shaft 331, the guiding plate 21 extends to form the third axis X3, and the angle between the third axis X3 and the fourth axis X4 is the acute angle. That is, the motor 31 is disposed on a lower rear side or an upper rear side of the gearbox 34, thereby reducing a length of the entire machine and improving compactness of the structure. The motor 31 and the gearbox 34 are disposed obliquely, thereby increasing the space between the motor 31 and the controller 32 and improving the heat dissipation performance of the motor 31 and the controller 32. In addition, the air inlet 151 is disposed between the motor 31 and the battery pack, the controller 32 is located in the airflow channel between the air inlet 151 and the air outlet 161, and the controller 32 is disposed close to the air inlet 151, thereby improving the heat dissipation effect of the entire machine.

In above technical solution, the power tool includes the housing, the first holding part located on the top side of the housing, and the second holding part located on the side surface of the housing. The second holding part includes the first fixed part and the second fixed part connected to the housing, both of which are disposed with reference to the first connection area and the second connection area of the housing where the first holding part is connected. When viewed from the left-right direction perpendicular to the front-back direction, the first axis intersects with the second axis, and the angle between the first axis and the second axis is greater than or equal to 40° and less than or equal to 85°. Alternatively, when viewed from the left-right direction, the intersection point of the first axis and the second axis is located in the first connection area. Therefore, when a user holds and operates the power tool with two hands, the angle between the user's two hands is neither too small to cause fatigue nor too large to limit the holding area of one hand, thereby not affecting the user experience.

The present disclosure is not limited to the specific embodiments described above. Those of ordinary skill in the art can easily understand that there are many alternative solutions for the power tool within the principles and scope of the present disclosure. The protection scope of the present disclosure should be subject to the contents of the claims.

1. A power tool, comprising:
a housing, extending in a front-back direction and comprising a first connection area and a second connection area;
a first holding part, located on a top side of the housing, wherein a front end of the first holding part is connected to the first connection area, a rear end of the first holding part is connected to the second connection area, and the first holding part extends along a first axis; and
a second holding part, located on a side surface of the housing, wherein the second holding part comprises a first fixed part and a second fixed part both connected to the housing, and the first fixed part and the second fixed part are connected to form a second axis; and wherein when viewed from a left-right direction perpendicular to the front-back direction, the first axis intersects with the second axis, and an angle between the first axis and the second axis is greater than or equal to 40° and less than or equal to 85°.

2. The power tool according to claim 1, wherein the second holding part comprises:
a first section, extending from the first fixed part;
a second section, extending from the second fixed part; and
a third section, connected to the first section and the second section;
wherein the second holding part comprises an effective holding area located on at least one of the first section and the third section, and a length of the effective holding area decreases as the angle between the first axis and the second axis increases.

3. The power tool according to claim 1, wherein when viewed from the left-right direction, an intersection point of the first axis and the second axis is located in the first connection area, and the angle between the first axis and the second axis is greater than or equal to 45° and less than or equal to 65°.

4. (canceled)

5. The power tool according to claim 1, wherein in an up-down direction perpendicular to the front-back direction, a gravity center of the power tool is located between the first fixed part and the second fixed part.

6. The power tool according to claim 1, wherein the power tool further comprises a functional assembly accommodated in the housing, and the functional assembly comprises:
a motor, configured to drive an operating assembly that extends forward from a front end of the housing;
a gear assembly, in transmission connection with the motor; and
a gearbox, configured for accommodating the gear assembly;
wherein the functional assembly is provided with a contour area composed of an outer contour of the gearbox and an outer contour of the motor, and when viewed from the left-right direction, the second fixed part is at least partially located in the contour area.

7. The power tool according to claim 6, wherein
a motor shaft of the motor extends in the left-right direction;
an output shaft of the gear assembly is disposed parallel to the motor shaft; and
in the front-back direction, a center of the second fixed part is located between the motor shaft and the output shaft.

8. The power tool according to claim 6, wherein the operating assembly comprises a guiding plate extending along a third axis, and the first fixed part and the second fixed part are located on both sides of the third axis in an up-down direction perpendicular to the front-back direction, respectively.

9. The power tool according to claim 8, wherein an angle between the first axis and the third axis ranges from 0° to 15°.

10. The power tool according to claim 8, wherein in a plane parallel to the guiding plate , a fourth axis is formed by connecting a center of a motor shaft and a center of an output shaft, and an angle between the fourth axis and the third axis is an acute angle; and in a plane parallel to the guiding plate, a projection point of the second fixed part is located on a lower front side of a projection point of the motor shaft.

11. The power tool according to claim 7, wherein a gravity center of the power tool is located between the motor shaft and the output shaft in the front-back direction.

12. The power tool according to claim 1, wherein the second holding part is configured as a linear connection structure or a curved structure between the first fixed part and the second fixed part.

13. The power tool according to claim 1, wherein the housing defines an air inlet and an air outlet in fluid communication with the air inlet, an airflow channel is formed between the air inlet and the air outlet, and the power tool further comprises:
a motor, accommodated in the housing and located in the airflow channel;
a fan, configured to be driven to rotate by the motor; and
a controller, electrically connected to the motor, wherein the controller is located upstream of the motor in the airflow channel and disposed close to the air inlet.

14. The power tool according to claim 13, wherein the housing defines:
a first chamber, configured to accommodate the motor and defining the air outlet; and
a second chamber, configured to accommodate the controller and defining the air inlet;
wherein the first chamber is in fluid communication with the second chamber.

15. The power tool according to claim 14, wherein the power tool further comprises a partition device disposed between the first chamber and the second chamber, and the partition device comprises:
a partition plate, extending parallel to the controller, wherein a channel configured for allowing airflow to flow is formed between the partition plate and the controller, so as to guide the airflow entering from the air inlet to the first chamber.

16. The power tool according to claim 15, wherein the partition device comprises a cover, and the cover comprises:
a diversion wall, disposed around peripheral of the fan, wherein a guiding port corresponding to the air outlet is defined on the diversion wall; and
a transverse wall, connected between the diversion wall and the motor, wherein the first chamber is separated from the second chamber by the transverse wall, and a fluid opening connecting the first chamber and the second chamber is formed between the transverse wall and the partition plate.

17. A power tool, comprising:
a housing, extending in a front-back direction and comprising a first connection area and a second connection area;
a motor, receiving in the housing;
a first holding part, located on a top side of the housing, wherein a front end of the first holding part is connected to the first connection area, a rear end of the first holding part is connected to the second connection area, and the first holding part extends along a first axis; and
a second holding part, located on a side surface of the housing, wherein the second holding part comprises a first fixed part and a second fixed part both connected to the housing; the first fixed part and the second fixed part are connected to form a second axis; and when viewed from a left-right direction, the first axis intersects with the second axis, and the motor is at least partially located in an angle between the first axis and the second axis.

18. The power tool according to claim 17, wherein an intersection point of the first axis and the second axis is located in the first connection area.

19. A power tool, comprising:
a housing, extending in a front-back direction;
a motor, comprising a motor shaft extending in a left-right direction perpendicular to the front-back direction;
a first holding part, located on a top side of the housing; and
a second holding part, located on a side surface of the housing; wherein the second holding part comprises a first fixed part and a second fixed part both connected to the housing, and the second fixed part is located at a front side of the motor shaft in the front-back direction.

20. The power tool according to claim 19, wherein the second holding part comprises an effective holding area, and a length of the effective holding area decreases as a distance between the motor shaft and the second fixed part increases in the front-back direction.

21. The power tool according to claim 19, wherein the power tool further comprises a gear assembly comprising an output shaft, and the second holding part is between the output shaft and the motor shaft in the front-back direction.
